(19) United States
(12) Patent Application Publication
(10) Pub. No.: US 2026/0285346 A1
(43) Pub. Date: Sep. 24, 2026

(54) PROVIDING NOTIFICATION OF INTERSECTION PREEMPTION STATUS TO AN OPERATOR OF A REQUESTING VEHICLE

(71) Applicant: PANASONIC CORPORATION OF NORTH AMERICA D/B/A SMART MOBILITY OFFICE, Denver, CO (US)

(72) Inventors: Ryota Ohnishi, Parker, CO (US); Kjeld Lindsted, Cherry Valley, CA (US)

(21) Appl. No.: 19/087,835

(22) Filed: Mar. 24, 2025

(51) Int. Cl. B60W 50/14; G08G 1/087

(52) U.S. Cl. CPC B60W 50/14; G08G 1/087; B60W 2050/143; B60W 2050/146

(57) ABSTRACT

Methods and systems for providing intersection preemption notification to an operator of a vehicle are provided. The methods and system are provided to increase safety at an intersection as emergency vehicles, for example, traverse the intersection during an emergency response. The methods can include receiving a request for intersection preemption from a computing device integrated into a first vehicle approaching an intersection, determining intersection preemption status based upon the received request from the first vehicle and any other received requests from one or more additional vehicles, transmitting the intersection preemption status to the first vehicle, and causing a notification to be output to the operator of the first vehicle by a human machine interface (HMI) within the first vehicle, the notification indicating whether the first vehicle has priority to traverse the intersection. The systems can include appropriate hardware the implementing the systems as described.

### FIELD OF THE INVENTION

The present disclosure relates to the field of intersection preemption and, more specifically, to providing preemption status to requesting vehicles.

### BACKGROUND

Connected Vehicle (CV) data is data collected/received from vehicles on the road, including location, speed, and potentially other contextual data elements. In some examples, the vehicle data can include vehicle-specific requests such as a request for emergency preemption at an intersection such that a requesting emergency vehicle has priority access to traverse the intersection.

There are various types of existing vehicle communication systems. Vehicle-to-everything (V2X) communications includes devices and systems that allow one or more vehicles to communicate with other vehicles (using, for example, vehicle-to-vehicle (V2V) communications), infrastructure (using, for example, vehicle-to-infrastructure (V2I) communications), and/or pedestrians (using, for example, vehicle-to-pedestrian (V2P) communications). Intelligent Transportation Systems (ITS) sometimes utilize V2X systems to manage traffic flow, manage lane occupancy, facilitate toll collection, track freight, provide road condition alerts, and the like. Most ITS applications rely on the situation or cooperative awareness, which is based on periodic and event-driven broadcast of messages such as basic safety messages (BSM) between vehicles and other data collecting/receiving devices.

As noted above, a CV can transmit a request using one or more vehicle communication systems for preemption at an intersection. For example, a first responder vehicle such as an ambulance, police vehicle, fire truck, or other similar first responder vehicle generally has the right of way when approaching an intersection, even if the light is red. Existing preemption systems are configured to determine what vehicle has the right-of-way through an intersection and to update the traffic lights in an intersection to reflect the determined preemption. However, in some examples, current preemption status can be confusing to first responders if, for example, the intersection lights do not change immediately or if multiple emergency vehicles are approaching the intersection from different directions.

### SUMMARY

In at least one example as described herein, a method of providing intersection preemption notification to an operator of a vehicle is provided. The method includes receiving, by a processing device, a request for intersection preemption from a computing device integrated into a first vehicle approaching an intersection; determining, by the processing device, intersection preemption status based upon the received request from the first vehicle and any other received requests from one or more additional vehicles; transmitting, by the processing device, the intersection preemption status to the computing device integrated into the first vehicle; and causing, by the computing device integrated into the first vehicle, a notification to be output to the operator of the first vehicle by a human machine interface (HMI) operably connected to the computing device, the notification indicating whether the first vehicle has priority to traverse the intersection.

Implementations of the method of providing intersection preemption notification to an operator of a vehicle can include one or more of the following features.

In examples of the method, determining the intersection preemption status can include can include transmitting, by the processing device, a request to an intersection controller for intersection status and preemption information; receiving, by the processing device, a response from the intersection controller, the response including the intersection status and preemption information; and determining, by the processing device, the intersection preemption status based upon the received response from the intersection controller. In some additional examples, the method can further include determining, by the processing device, location information related to the first vehicle from the request for intersection preemption; determining, by the processing device, an appropriate intersection controller based upon the determined location information; and transmitting, by the processing device, the request to the appropriate intersection controller for intersection status and preemption information.

In examples of the method, the notification can include at least one of an audible notification and a visual notification to the operator of the first vehicle indicating whether the first vehicle has priority to traverse the intersection. In some additional examples, the HMI can include one or more of an audio output device integrated into the first vehicle, a visual display integrated into the vehicle, an audio output device removably coupled to and operably connected to the computing device, and a portable computing device removably coupled to and operably connected to the computing device.

In examples of the method, the first vehicle can be an emergency response vehicle. In some additional examples, the one or more additional vehicles can include a second emergency response vehicle requesting preemption for the intersection.

In at least one additional example as described herein, a system for providing intersection preemption notification to an operator of a vehicle is provided. The system can include a remote computing device including a processing device, and a first computer-readable medium operably connected to the processing device. The first computer-readable medium can include first instructions that, when executed, cause the processing device to receive a request for intersection preemption from a computing device integrated into a first vehicle approaching an intersection; determine intersection preemption status based upon the received request from the first vehicle and any other received requests from one or more additional vehicles, and transmit the intersection preemption status to the computing device integrated into first vehicle. The system can further include the first vehicle. The first vehicle can include a computing device integrated into the first vehicle and a second computer-readable medium operably connected to the computing device. The second computer-readable medium can include second instructions that, when executed, cause the computing device to output a notification to be output to the operator of the first vehicle by a human machine interface (HMI) operably connected to the computing device, the notification indicating whether the first vehicle has priority to traverse the intersection.

Implementations of the system for providing intersection preemption notification to an operator of a vehicle can include one or more of the following features.

In some examples of the system, the first instructions for causing the processing device to determine the intersection preemption status further include instructions to transmit a request to an intersection controller for intersection status and preemption information; receive a response from the intersection controller, the response including the intersection status and preemption information; and determine the intersection preemption status based upon the received response from the intersection controller. In some additional examples, the first instructions further include instructions that, when executed, cause the processing device to determine location information related to the first vehicle from the request for intersection preemption; determine an appropriate intersection controller based upon the determined location information; and transmit the request to the appropriate intersection controller for intersection status and preemption information.

In some examples of the system, the notification can include at least one of an audible notification and a visual notification to the operator of the first vehicle indicating whether the first vehicle has priority to traverse the intersection. In some additional examples, the HMI can include one or more of an audio output device integrated into the first vehicle, a visual display integrated into the vehicle, an audio output device removably coupled to and operably connected to the computing device, and a portable computing device removably coupled to and operably connected to the computing device.

In some examples of the system, the first vehicle can be an emergency response vehicle. In additional examples, the one or more additional vehicles can include a second emergency response vehicle requesting preemption for the intersection.

In at least one additional example as described herein, a second exemplary method can include a method of providing intersection preemption notification to an operator of a vehicle. The second method can include determining, by a processing device, whether the vehicle is operating in an emergency condition; upon determining that the vehicle is operating in an emergency condition, generating, by the processing device, a request for intersection preemption when the vehicle approaches an intersection; transmitting, by the processing device, the request for intersection preemption; receiving, by the processing device, a response to the request for intersection preemption, the response including an indication of whether the vehicle has been granted intersection preemption; determining, by the processing device, if the vehicle has been granted intersection preemption based upon the received response; and causing, by the processing device, a notification to be displayed to the operator of the vehicle via a human machine interface (HMI), the notification indicating whether the vehicle has been granted intersection preemption.

Implementations of the second method of providing intersection preemption notification to an operator of a vehicle can include one or more of the following features.

In some examples of the second method, the notification can include at least one of an audible notification and a visual notification to the operator of the first vehicle indicating whether the first vehicle has priority to traverse the intersection. In some additional examples, the HMI can include one or more of an audio output device integrated into the first vehicle, a visual display integrated into the vehicle, an audio output device removably coupled to and operably connected to the computing device, and a portable computing device removably coupled to and operably connected to the computing device.

In some examples of the second method, the vehicle can be an emergency response vehicle.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a sample connected vehicle, in accordance with at least one example of the present disclosure.

FIG. 2 is a block diagram of a sample connected vehicle system, in accordance with at least one example of the present disclosure.

FIG. 3 is a block diagram of a sample preemption request and notification system, in accordance with at least one example of the present disclosure.

FIG. 4 is a sample flow chart illustrating a process for requesting and determining preemption status by a connected vehicle, in accordance with at least one example of the present disclosure.

FIG. 5 is a sample flow chart illustrating a process for a remote computing device to receive and process a request for preemption from a requesting vehicle, in accordance with at least one example of the present disclosure.

FIG. 6 is a sample flow chart illustrating a process for an intersection controller to receive and process a request for intersection status from a requesting device, in accordance with at least one example of the present disclosure.

FIG. 7 is a sample computing device configured to implement at least one process as disclosed herein, in accordance with at least one example of the present disclosure.

### DETAILED DESCRIPTION

The present disclosure is directed to methos and systems for providing intersection preemption status to the operator of an emergency vehicle approaching an intersection and requesting preemption, i.e., priority through the intersection. As noted above, there are existing systems for determining priority and preemption at an intersection. These systems receive preemption requests from one or more vehicles, determine which (if any) requesting vehicle has priority, and instructs an intersection controller to update the traffic lights at the intersection accordingly. However, in a real-world environment, such a system can still have drawbacks. For example, network and/or processing delays can cause the preemption system to require additional time in making a determination and updating the traffic lights in an intersection. In such an example, the operator of an emergency vehicle can be approaching a red light at an intersection. As the preemption system has been delayed (do to various computation issues), the traffic lights at the intersection may be delayed in updating, thereby causing unnecessary delay to the emergency vehicle. If the operator of the emergency vehicle decides not to stop and instead enters the intersection before the traffic lights are correctly updated, there is an increased risk of accident within the intersection.

The drawbacks of existing preemption systems can be especially noticeable when multiple emergency vehicles, each requesting preemption through the intersection, are approaching the same intersection from different directions. In such an example, the operator of each emergency vehicle may thing they have preemption at the intersection regardless of current traffic light status. As such, the two (or more) emergency vehicles may cause an accident as they traverse the intersection, potentially at a high rate of speed. As such, while existing preemption systems are generally adept at processing requests and organizing priority for oncoming vehicles, they lack safety features such as providing direct feedback to operators of the emergency vehicles related to their preemption status.

Thus, the present disclosure is related to systems and methods for providing direct feedback to operators of emergency and first responder vehicles. The feedback can include audio and/or video feedback displayed or otherwise presented to the operator of the vehicle via a human machine interface (HMI) integrated into the vehicle. Rather than depend on external indicators such as the intersection traffic lights to provide notification of preemption status, the present disclosure considers and teaches a direct in-vehicle notification to the operator (or another occupant) of the emergency vehicle. Such an approach can be expanded to include a group of vehicles (e.g., multiple fire trucks traveling together, or a combination of ambulances/fire trucks/police vehicles responding to an emergency), providing preemption notification each vehicle operator within the group of vehicles. The notifications of preemption status can be displayed or otherwise output via existing components within the vehicle such as a speaker, a integrated dashboard or console display, or other similar output devices within the vehicle. Additionally or alternatively, the notification can be output via another device integrated into or otherwise operably connected to the vehicle such as a table computing device, a cellular telephone (or smartphone), a laptop computer (either integrated into the vehicle or removable attached and operably connected to the vehicle during operation), and other similar portable and/or removable devices.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Connected Vehicle

In some examples, a connected vehicle can be configured to collect information related to operation of the vehicle and distribute this information to one or more receiving devices. In certain implementations, a connected vehicle can be configured to transmit a basic safety message (BSM) ten times per second. Nearby receiving devices such as other connected vehicles and roadside equipment such as RSUs receive the messages.

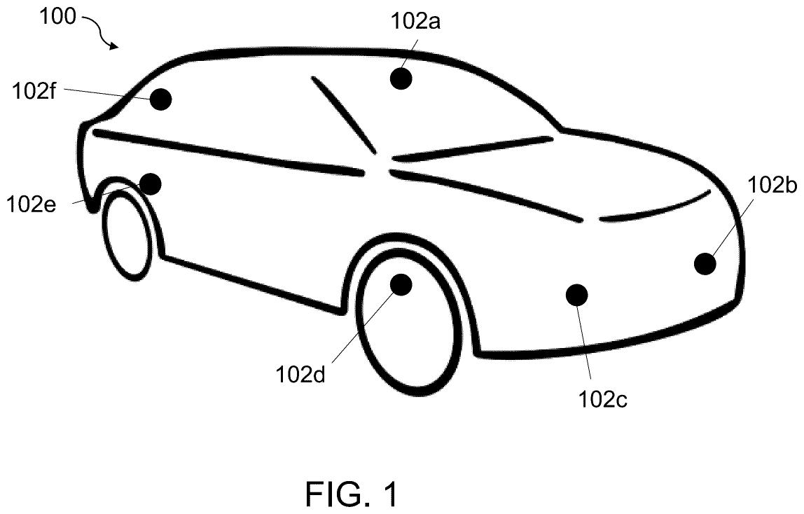

Typically, a BSM can include contextual data about what is happening on a vehicle. The information contained within a typical BSM is based upon information collected from a series of sensors integrated into a connected vehicle. For example, FIG. 1 illustrates a connected vehicle 100. As shown in FIG. 1, the connected vehicle 100 can include a number of sensors 102a-102f, collectively referred to herein as sensors 102. For example, the connected vehicle 100 can include a lane departure sensor 102a, an active park assist sensor 102b, a front object sensor 102c, a tire pressure sensor 102d, a wheel speed sensor 102e, and a rear object sensor 102f. However, it should be noted that the sensors 102 as shown in FIG. 1 are provided by way of example only. In some examples, a connected vehicle can include fewer or more sensors than those as shown in FIG. 1. For example, a connected vehicle can include one or more of lane departure sensors, night vision sensors, front object cameras, vehicle speed sensors, pedestrian warning sensors, airbag sensors, front object sensors, active park assist sensors, tire pressure sensors, rear object cameras, side curtain sensors, blind spot detection sensors, cross traffic alert sensors, wheel speed sensors, collision sensors, steering angle sensors, adaptive cruise control sensors, automatic brake actuator sensors, and other similar connected vehicle sensors. Additionally, for emergency and first responder vehicles, the vehicle can further include alerting device such as sirens, lightbars and other flashing lights, microphones and speakers for broadcasting announcements, and other similar alerting devices.

### Connected Vehicle System and Data Collection

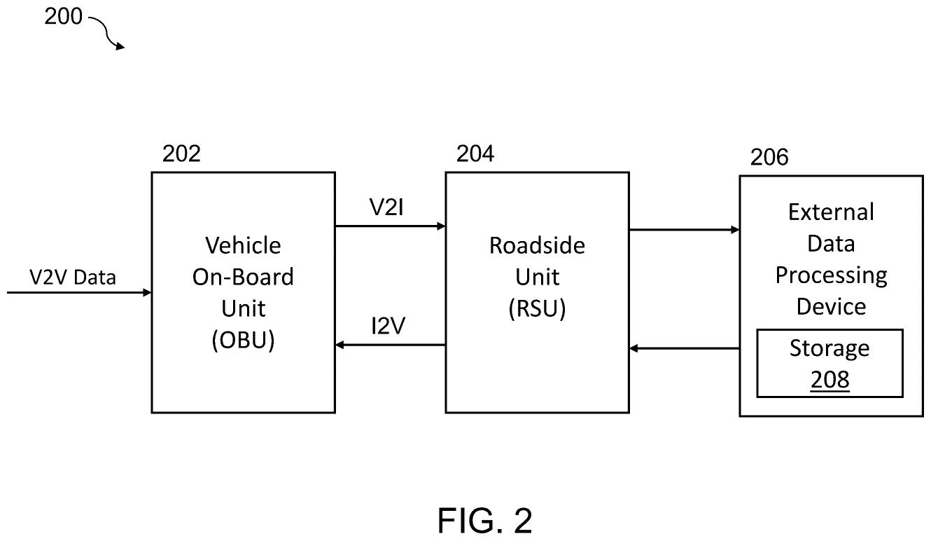

FIG. 2 illustrates a sample vehicle communication system 200. As shown in FIG. 2, one or more processing devices can be configured to communicate via one or more data communication connections to exchange data therebetween. For example, as shown in FIG. 2, the system 200 can include a vehicle onboard unit 202, a roadside unit 204, and external data processing device 206. As further shown in FIG. 2, the OBU 202 can be configured to receive V2V data from one or more additional vehicles located in close proximity to the OBU 202. The OBU 202 can be further configured to transmit data collected related to the vehicle associated with the OBU 202 to the RSU 204. For example, OBU 202 can be configured to transmit the collected data to the RSU 204 as a vehicle-to-infrastructure (V2I) communication.

As further shown in FIG. 2, the RSU 204 can be configured to receive the V2I communication from the OBU 202. The RSU 204 can be further configured to process the received information and transmit at least a portion of the information to the external data processing device 206. In certain examples, the RSU 204 can be configured to transmit the information as encoded vehicle data. The device 206 can be configured to receive the information from the RSU 204 and store the received information at storage 208. As described herein, the storage 208 can be implemented as a computer-readable medium operably coupled to the external data processing device 206 such that information stored on storage 208 is accessible to the device 206.

As also shown in FIG. 2, the external data processing device 206 can be configured to transmit data to the RSU 204. The RSU 204 can be configured to process the received information and, if applicable, transmit at least a portion of the received information to the OBU 202 as, for example, an infrastructure-to-vehicle (I2V) communication.

It should be noted that, as used herein, V2X communications can include all communication directions and inter-device combinations as described herein. For example, V2X communications can include V2V communications, V2I communications, I2V communications, V2N (vehicle to network) communications, and other similar inter-device communications associated with a smart vehicle data collection system as described herein.

In such an example system as shown in FIG. 2, data collected by the OBU 202 about the connected vehicle in which the OBU 202 is installed is transmitted to the external data processing device 206 the RBU 204. The device 206 can be configured to analyze the messages and data collected by the OBU 202 to detect any events that are to be communicated back to the OBU 202 such as updated traffic condition information, emergency information, and other similar information. The device 206 is configured to transmit such event information back to the OBU 202 via the RBU 204 as further shown in FIG. 2.

In addition to BSMs as described above, information received from one or more connected vehicles can further include signal request messages (SRMs). For example, an RSU can receive an SRM when a vehicle is requesting priority or preemption at an intersection. In some examples, each “request” can generate multiple messages (SRMs), including an initial message type when the request is first initiated, updated messages as the vehicle gets closer to the middle of an intersection, and finally messages to let the intersection know that the vehicle has made it through. Therefore, a count of SRMs would review a higher number of messages that result from much fewer vehicle request attempts. Therefore, as described herein below, to properly determine additional information related to a vehicle passing through an intersection (such as, for example, total traversal time), additional processing and aggregation of the SRMs as received can be performed.

As such, and as noted above, as the number of connected vehicles continues to increase, so too does the data collected by those connected vehicles (e.g., BSMs, SRMs, and other similar messages received from connected vehicles), the amount of information that can be determined and analyzed related to, for example, movement of connected vehicles, intersection performance (e.g., average traversal times), and other similar information can be determined and analyzed.

### Preemption Request System

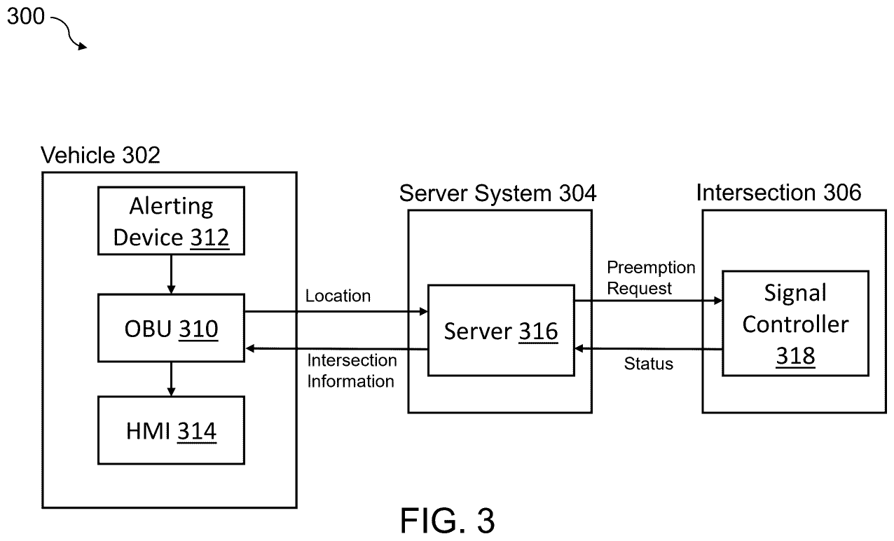

FIG. 3 illustrates a sample preemption notification system 300 in accordance with the present disclosure. As shown in FIG. 3, the system 300 can include one or more vehicles 302 (e.g., a connected emergency vehicle as described herein), a server system 304 in communication with the vehicle, and a connected intersection 306 in communication with the server 304. As described herein, the system 300 could be configured such that vehicle 302 is configured to transmit and receive information to/from server system 304, and the server system is configured to transmit and receive information to/from the intersection 306.

As shown in FIG. 3, the vehicle 302 can include various components such as OBU 310, alerting device 312, and HMI 314. In accordance with the systems and methods as described herein, the OBU can be configured to transmit various information such as location and preemption request information to the server system 304. Similarly, the OBU 310 can be configured to receive information from the server system 304 such as, for example, intersection information including preemption request status. To determine whether a preemption request should be submitted, the OBU 310 can receive information from the alerting device 312 related to, for example, an emergency response situation in which the vehicle is responding to a received call for emergency help. In such a situation, the OBU 310 can determine both location information as well as preemption request information and transmit the collected information to the server system 304. A remote computing device such as server 316, as shown in server system 304, can receive and process the request from the OBU 310. As further shown in FIG. 3, the server 316 can transmit a preemption request to a signal controller 318 within intersection 306. The signal controller 318 can process the preemption request and provide a status response to the server 316. The server 316 can further process the status response and generate a response to the OBU 310, the response including intersection information and the preemption status information as received from the signal controller 318. Based upon the intersection information and the preemption status information, the OBU 310 can provide an output to the driver of the vehicle 302 via the HMI 314.

In certain examples, the HMI 314 can include various options. For example, the HMI 314 can be a built in display in the dashboard and/or center console of the vehicle 302. In some examples, the HMI 314 can be a separate device such a mobile phone or laptop computing device operably connected to the vehicle 302 and the OBU 310 such that the OBU can display information on the separate device. In such an example, the separate device can establish communication with the vehicle control access network (CAN) bus for communication with various components such as the OBU 310. In such an example, the separate device can function as the HMI 314 by receiving, processing, and displaying information as received from the OBU 310 during operation of the vehicle 302 including preemption status notification information.

Another example for the HMI 314 can include speakers or other audio output devices integrated into the vehicle 302. Depending upon the preemption status information as received form the server 316, the OBU 310 can output a custom sound or notification via the speakers (function as the HMI 314) providing an indication to the operator of the vehicle 302 their current preemption status.

It should be noted that various components as shown within FIG. 3 are provided by way of example only. Similarly, the labeled data flow examples as shown in FIG. 3 are provided by way of example only and could vary depending upon the implementation of the system 300.

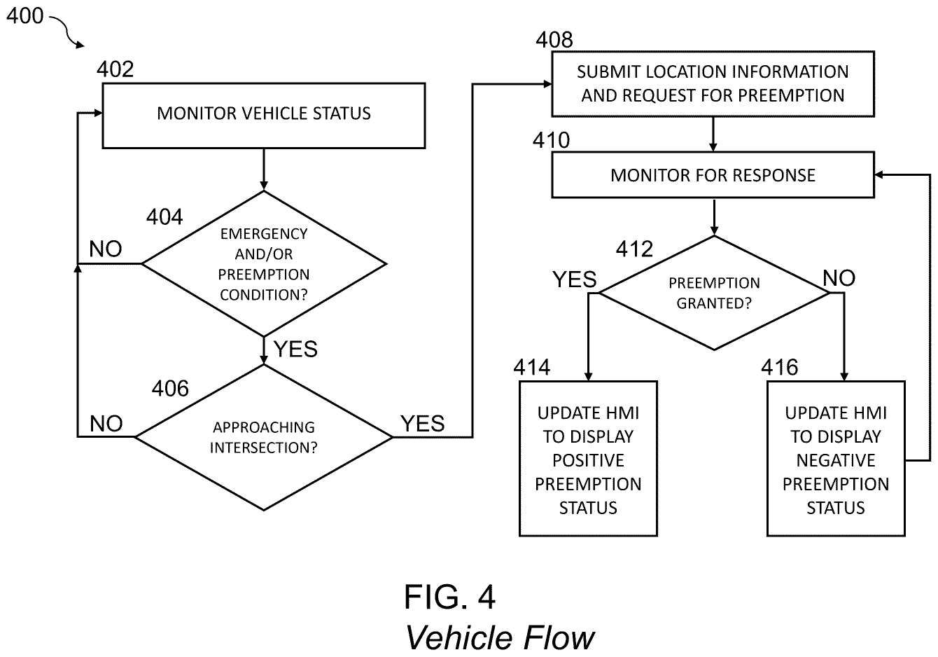

The operation of the individual components as contained within system 300 (and illustrated in FIG. 3), including the vehicle 302, the server system 304, and the intersection 306, is further explained in the process flow diagrams as shown in FIGS. 4, 5, and 6, and described in the following detailed description.

### Preemption System Process Flow Examples

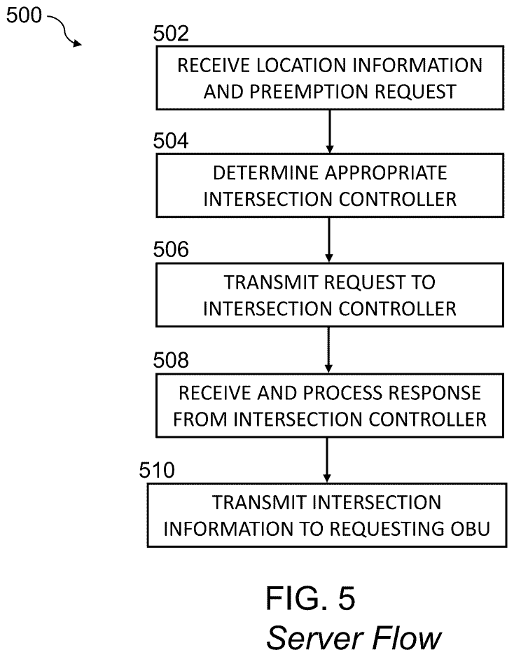

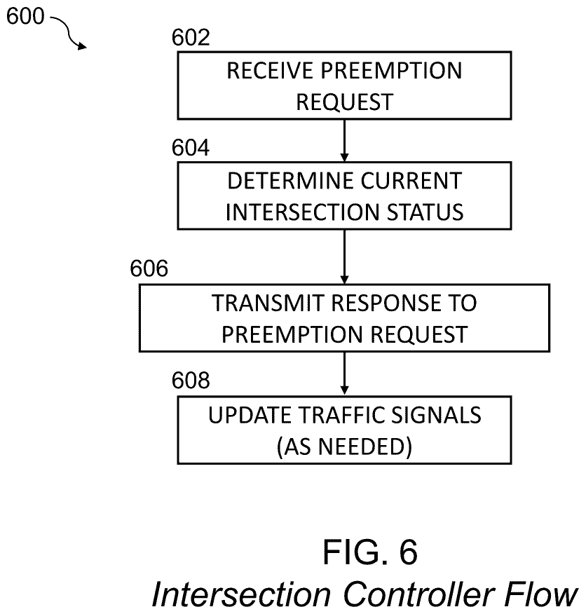

As noted above, FIGS. 4, 5, and 6 illustrate various sample process flows for each component within the system 300 as shown in FIG. 3. More specifically, FIG. 4 illustrates a sample process 400 showing a sample process flow for a processing device within the vehicle 302 (e.g., OBU 310), FIG. 5 illustrates a sample process 500 showing a sample process flow for a processing device within the server system 304 (e.g., the server 316), and FIG. 6 illustrates a sample process 600 showing a sample process flow for a processing device within the intersection 306 (e.g., signal controller 318).

Referring now to FIG. 4, the sample process 400 illustrates an exemplary set of process flow steps that may be taken by a vehicle processing device such as OBU 310 in a preemption notification system such as that described herein. The process 400 can begin as the processing device monitors 402 vehicle status. To continue the examples and implementations as described herein, monitoring 402 the vehicle status can include monitoring operator actions as well as the current status of one or more alerting devices, such as alerting device 312, to determine whether the vehicle is operating in an emergency and/or preemption condition. Based upon the monitored vehicle status, the processing device can determine 404 whether the vehicle is in an emergency and/or preemption condition. If the processing device determines 404 the vehicle is not in an emergency condition, the processing device can continue to monitor 402 the vehicle status. Conversely, if the processing device does determine 404 that the vehicle is operating in an emergency condition, the processing device can determine 406 whether the vehicle is approaching an intersection. If the processing device determines 406 that the vehicle is not approaching an intersection, the processing device can continue to monitor 402 the vehicle status. Conversely, if the processing device does determine 406 that the vehicle is approaching an intersection, the processing device can submit 408 location information and a request for preemption to a remote computing device as described herein.

After submitting 408 the request, the processing device can monitor 410 communications with the remote computing device for response. Upon receiving a response, the processing device can determine 412 whether preemption has been granted by the remote computing device in response to the request for preemption. If the processing device determines 412 that preemption has been granted, the processing device can update 414 an HMI to display the positive preemption status to the operator of the vehicle such that the operator of the vehicle can traverse the intersection safely and with priority. Conversely, if the processing device determines 412 that preemption has not been granted, the processing device can update 416 the HMI to display the negative preemption status such that the operator of the vehicle can stop the vehicle or otherwise avoid traversing the intersection in a priority manner. The processing device can continue to monitor 412 communications with the remote computing device for another response including an indication of preemption for the vehicle.

The process 400 can continue after the vehicle has traversed the intersection. For example, the processing device can return to monitoring 40 to the vehicle status after the vehicle has traversed the intersection. By monitoring changes in the location information and any potential changes to the emergency condition, the processing device can submit subsequent requests for intersection preemption and priority as the vehicle continues on its route to the emergency. As such, process 400 can continue indefinitely until the vehicle reaches its final destination during an emergency call.

Referring now to FIG. 5, the sample process 500 illustrates an exemplary set of process flow steps that may be taken by a remote computing device such as server 316 in a preemption notification system such as that described herein. The process 500 can begin as the remote computing device receives 502 location information and preemption request information from a connected vehicle. The remote computing device can process the location information and preemption request to determine 504 the appropriate intersection controller for the vehicle's current location. Once the appropriate intersection controller has been determined, the remote computing device can transmit 506 the request to the intersection controller on behalf of the vehicle for preemption and priority access to the intersection. In response to the transmitted request, the remote computing device can receive 508 and process the response from the intersection controller. As described herein, the response from the intersection controller can include current status information related to the intersection, a response to the preemption request from the vehicle, and other information related to the current preemption status of the intersection. The remote computing device can process the received information from the intersection controller and generate a response to the vehicle. The remote computing device can transmit 510 the response to the vehicle including the current intersection information as well as the response to the preemption request as received from the intersection controller.

Referring now to FIG. 6, the sample process 600 illustrates an exemplary set of process flow steps that may be taken by an intersection controller such as signal controller 318 in a preemption notification system such as that described herein. The process 600 can begin when the intersection controller receives 602 an preemption request from, for example, a remote computing device as described above in regards to FIG. 5. The intersection controller can determine 604 current intersection status based upon both the received 602 preemption request as well as other received preemption requests (from additional emergency vehicles as described herein) and other information related to the current operating status of the intersection. Based upon the current intersection status, the intersection controller can generate and transmit 606 a response to the preemption request as received from the remote computing device. As needed, and based upon the response to the preemption request, the intersection controller can update 608 the traffic signals and traffic lights within the intersection to reflect any changes in the preemption and priority status of the intersection.

As described herein, the remote computing device can be a cloud-based computing device located at a geographic location away from the vehicle and/or the intersection as described in the above example and sample implementation. In other examples, the remote computing device can be located at or near the intersection for reduced time needed to transmit and receive information from the intersection controller. However, to reduce overall resources and improve the efficiency of the notification system, the remote computing device may be integrated into a cloud-based system as described above such that requests for multiple vehicles in varying geographic locations can be processed simultaneously and efficiently by a single remote computing device.

It should be noted that the processes 400, 500, and 600 as shown in FIGS. 4, 5, and 6 are provided by way of example only. The individual steps as shown in each of processes 400, 500, and 600 can be altered based upon the design and integration of a preemption notification system as described herein. As such, the processes as shown in FIGS. 4, 5, and 6 are for illustrative purposes only and are not intended to unduly limit the disclosure as described herein.

### Sample Computing System

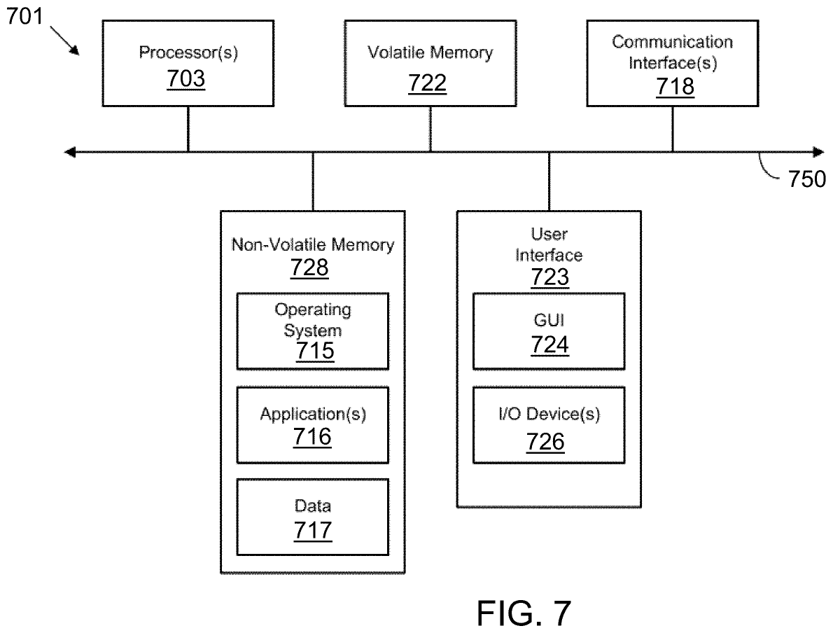

FIG. 7 depicts a block diagram of a computing device 701 useful for practicing the computing and/or processing devices as described herein and implementing the processes as shown, for example, in FIGS. 4, 5, and 6 and described above. In some examples, the OBU 310 as shown in FIG. 3 and described above can include one or more components as shown in computing device 701. Similarly, the server 316 can include similar components and operational details as the computing device 701 as shown in FIG. 7 and described below.

The computing device 701 includes one or more processors 703, volatile memory 722 (e.g., random access memory (RAM)), non-volatile memory 728, user interface (UI) 723, one or more communications interfaces 718, and a communications bus 750. The computing device 701 may also be referred to as a computer or a computer system.

The non-volatile memory 728 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 723 can include a graphical user interface (GUI) 724 (e.g., a touchscreen, a display, etc.) and one or more input/output (I/O) devices 726 (e.g., a mouse, a keyboard, a microphone, one or more speakers, one or more cameras, one or more biometric scanners, one or more environmental sensors, and one or more accelerometers, etc.).

The non-volatile memory 728 stores an operating system 715, one or more applications 716, and data 717 such that, for example, computer instructions of the operating system 715 and/or the applications 716 are executed by processor(s) 703 out of the volatile memory 722. In some examples, the volatile memory 722 can include one or more types of RAM and/or a cache memory that can offer a faster response time than a main memory. Data can be entered using an input device of the GUI 724 or received from the I/O device(s) 726. Various elements of the computer 701 can communicate via the communications bus 750.

The illustrated computing device 701 is shown merely as an example client device or server and can be implemented by any computing or processing environment with any type of machine or set of machines that can have suitable hardware and/or software capable of operating as described herein.

The processor(s) 703 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor 703 can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 703 can be analog, digital or mixed. In some examples, the processor 703 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The communications interfaces 718 can include one or more interfaces to enable the computing device 701 to access a computer network such as a LAN, a WAN, a Personal Area Network (PAN), or the Internet through a variety of wired and/or wireless connections, including cellular connections.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method of providing intersection preemption notification to an operator of a vehicle, the method comprising:
receiving, by a processing device, a request for intersection preemption from a computing device integrated into a first vehicle approaching an intersection;
determining, by the processing device, intersection preemption status based upon the received request from the first vehicle and any other received requests from one or more additional vehicles;
transmitting, by the processing device, the intersection preemption status to the computing device integrated into the first vehicle; and
causing, by the computing device integrated into the first vehicle, a notification to be output to the operator of the first vehicle by a human machine interface (HMI) operably connected to the computing device, the notification indicating whether the first vehicle has priority to traverse the intersection.

2. The method of claim 1, wherein determining the intersection preemption status comprises:
transmitting, by the processing device, a request to an intersection controller for intersection status and preemption information;
receiving, by the processing device, a response from the intersection controller, the response comprising the intersection status and preemption information; and
determining, by the processing device, the intersection preemption status based upon the received response from the intersection controller.

3. The method of claim 2, further comprising:
determining, by the processing device, location information related to the first vehicle from the request for intersection preemption;
determining, by the processing device, an appropriate intersection controller based upon the determined location information; and
transmitting, by the processing device, the request to the appropriate intersection controller for intersection status and preemption information.

4. The method of claim 1, wherein the notification comprises at least one of an audible notification and a visual notification to the operator of the first vehicle indicating whether the first vehicle has priority to traverse the intersection.

5. The method of claim 4, wherein the HMI comprises one or more of an audio output device integrated into the first vehicle, a visual display integrated into the vehicle, an audio output device removably coupled to and operably connected to the computing device, and a portable computing device removably coupled to and operably connected to the computing device.

6. The method of claim 1, wherein the first vehicle is an emergency response vehicle.

7. The method of claim 6, wherein the one or more additional vehicles includes a second emergency response vehicle requesting preemption for the intersection.

8. A system for providing intersection preemption notification to an operator of a vehicle, the system comprising:
a remote computing device comprising
a processing device, and
a first computer-readable medium operably connected to the processing device and comprising first instructions that, when executed, cause the processing device to
receive a request for intersection preemption from a computing device integrated into a first vehicle approaching an intersection;
determine intersection preemption status based upon the received request from the first vehicle and any other received requests from one or more additional vehicles, and
transmit the intersection preemption status to the computing device integrated into first vehicle; and
the first vehicle comprising
the computing device integrated into the first vehicle, and
a second computer-readable medium operably connected to the computing device and comprising second instructions that, when executed, cause the computing device to
output a notification to be output to the operator of the first vehicle by a human machine interface (HMI) operably connected to the computing device, the notification indicating whether the first vehicle has priority to traverse the intersection.

9. The system of claim 8, wherein the first instructions for causing the processing device to determine the intersection preemption status further comprise instructions to:
transmit a request to an intersection controller for intersection status and preemption information;
receive a response from the intersection controller, the response comprising the intersection status and preemption information; and
determine the intersection preemption status based upon the received response from the intersection controller.

10. The system of claim 9, wherein the first instructions further comprise instructions that, when executed, cause the processing device to:
determine location information related to the first vehicle from the request for intersection preemption;
determine an appropriate intersection controller based upon the determined location information; and
transmit the request to the appropriate intersection controller for intersection status and preemption information.

11. The system of claim 8, wherein the notification comprises at least one of an audible notification and a visual notification to the operator of the first vehicle indicating whether the first vehicle has priority to traverse the intersection.

12. The system of claim 11, wherein the HMI comprises one or more of an audio output device integrated into the first vehicle, a visual display integrated into the vehicle, an audio output device removably coupled to and operably connected to the computing device, and a portable computing device removably coupled to and operably connected to the computing device.

13. The system of claim 8, wherein the first vehicle is an emergency response vehicle.

14. The system of claim 13, wherein the one or more additional vehicles includes a second emergency response vehicle requesting preemption for the intersection.

15. A method of providing intersection preemption notification to an operator of a vehicle, the method comprising:
determining, by a processing device, whether the vehicle is operating in an emergency condition;
upon determining that the vehicle is operating in an emergency condition, generating, by the processing device, a request for intersection preemption when the vehicle approaches an intersection;
transmitting, by the processing device, the request for intersection preemption;
receiving, by the processing device, a response to the request for intersection preemption, the response comprising an indication of whether the vehicle has been granted intersection preemption;
determining, by the processing device, if the vehicle has been granted intersection preemption based upon the received response; and
causing, by the processing device, a notification to be displayed to the operator of the vehicle via a human machine interface (HMI), the notification indicating whether the vehicle has been granted intersection preemption.

16. The method of claim 15, wherein the notification comprises at least one of an audible notification and a visual notification to the operator of the first vehicle indicating whether the first vehicle has priority to traverse the intersection.

17. The method of claim 16, wherein the HMI comprises one or more of an audio output device integrated into the first vehicle, a visual display integrated into the vehicle, an audio output device removably coupled to and operably connected to the computing device, and a portable computing device removably coupled to and operably connected to the computing device.

18. The method of claim 15, wherein the vehicle is an emergency response vehicle.
